(19) United States
(12) Patent Application Publication
(10) Pub. No.: US 2017/0238532 A1
(43) Pub. Date: Aug. 24, 2017

(54) MEANS FOR TRANSPORTING OBJECTS

(71) Applicant: Todd Hild, Stanwood, WA (US)

(72) Inventor: Todd Hild, Stanwood, WA (US)

(21) Appl. No.: 15/052,814

(22) Filed: Feb. 24, 2016

(51) Int. Cl. A01M 99/00

(52) U.S. Cl. CPC A01M 99/00

(57) ABSTRACT

A means for transporting objects comprising a wrist strap and a tether, the tether configured to be coupled with the object to be transported. The tether may be configured for looping around the object, or for coupling with via removable fastener such as a gate lock. Wrist strap and tether may be substantially flexible or substantially rigid, depending on the needs of the user or the application. Wrist strap may be adjustable in diameter and may be fastened through any means of temporary fastening for cloth-like materials, such as hook-and-loop or snaps. Tether may be removably coupled with wrist strap, may be adjustable in length, and may be interchangeable for different applications. Wrist strap and tether may be configured for carrying heavy weights or withstanding particular environmental conditions such as freezing temperatures. Wrist strap may be padded and may have skin-protective qualities on the surface facing the user's wrist.

### FIELD OF THE INVENTION

This invention relates generally to means to support an article to be transported, and, more specifically, to means to shift the load of the supported article.

### SUMMARY OF THE INVENTION

This invention relates generally to means to support an article to be transported, and, more specifically, to means to shift the load of the supported article. One purpose of the device is to move the weight of the object from the hand muscles to the arm and shoulder muscles. Another purpose is to leave the hands free for transporting other objects. Additional purposes are disclosed elsewhere herein, and are not intended to limit the purpose or application of the device disclosed.

In some embodiments, the carrying device may be comprised of a strap configured for looping, and a tether, wherein the tether is disposed at one end of the strap and coupled thereto by at least one adjustable joint. In some embodiments, the strap configured for looping may include at least one means for adjusting the length of the strap. In some embodiments, the strap configured for looping may include at least one means for removably joining a first end of the strap with a second end of the strap in order to create a loop. In some embodiments, the strap configured for looping may include at least one means for adjusting the size of a loop. In some embodiments, the tether may include a first end and a second end, wherein the first end is coupled with the strap, and wherein the second end is coupled with at least one looping means.

In some embodiments, the carrying device, may be comprised of a strap with a first end and a second end, the strap including at least: an upper section disposed near the first end of the strap, the upper section including one half of a fastening system; a lower section disposed near the second end of the strap, the lower section including a complementary half of a fastening system, and an adjuster loop disposed at the second end of the strap, and a tether with a first end and a second end, wherein the first end of the tether is coupled with the second end of the strap, and wherein the second end of the tether is coupled with at least one looping means. In some embodiments, the fastening means includes a snap system. In some embodiments, the fastening means includes a hook-and-loop system. In some embodiments, the looping means includes a spring-loaded gate mechanism.

In addition to the foregoing, various other methods, systems and/or program product embodiments are set forth and described in the teachings such as the text (e.g., claims, drawings and/or the detailed description) and/or drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIG. 1 is an isometric front view of one embodiment of the means for transporting objects;

FIG. 2 is a rear view of one embodiment thereof;

FIG. 3 is an isometric view of one embodiment thereof;

FIG. 4 is an environmental isometric view thereof;

FIG. 5 is an environmental view of one embodiment of the means for transporting objects, showing the device in one method of use.

### DETAILED DESCRIPTION

This invention relates generally to means to support an article to be transported, and, more specifically, to means to shift the load of the supported article.

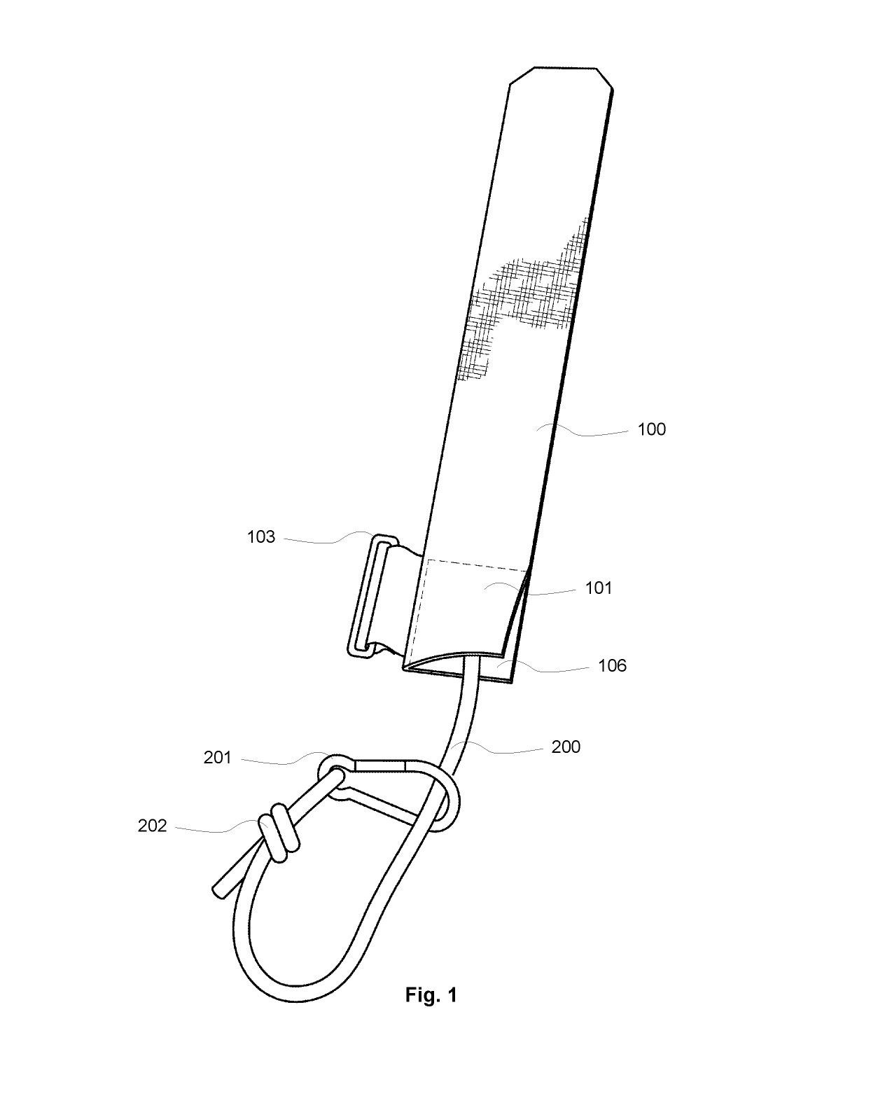

Specific details of certain embodiments of the invention are set forth in the following description and in FIGS. 1-5 to provide a thorough understanding of such embodiments. The present invention may have additional embodiments, may be practiced without one or more of the details described for any particular described embodiment, or may have any detail described for one particular embodiment practiced with any other detail described for another embodiment.

Importantly, a grouping of inventive aspects in any particular “embodiment” within this detailed description, and/or a grouping of limitations in the claims presented herein, is not intended to be a limiting disclosure of those particular aspects and/or limitations to that particular embodiment and/or claim. The inventive entity presenting this disclosure fully intends that any disclosed aspect of any embodiment in the detailed description and/or any claim limitation ever presented relative to the instant disclosure and/or any continuing application claiming priority from the instant application (e.g. continuation, continuation-in-part, and/or divisional applications) may be practiced with any other disclosed aspect of any embodiment in the detailed description and/or any claim limitation. Claimed combinations which draw from different embodiments and/or originally-presented claims are fully within the possession of the inventive entity at the time the instant disclosure is being filed. Any future claim comprising any combination of limitations, each such limitation being herein disclosed and therefore having support in the original claims or in the specification as originally filed (or that of any continuing application claiming priority from the instant application), is possessed by the inventive entity at present irrespective of whether such combination is described in the instant specification because all such combinations are viewed by the inventive entity as currently operable without undue experimentation given the disclosure herein and therefore that any such future claim would not represent new matter.

FIG. 1 is an isometric view of one embodiment of the means for transporting objects. The means for transporting objects is comprised essentially of a wrist strap 100 and a tether 200.

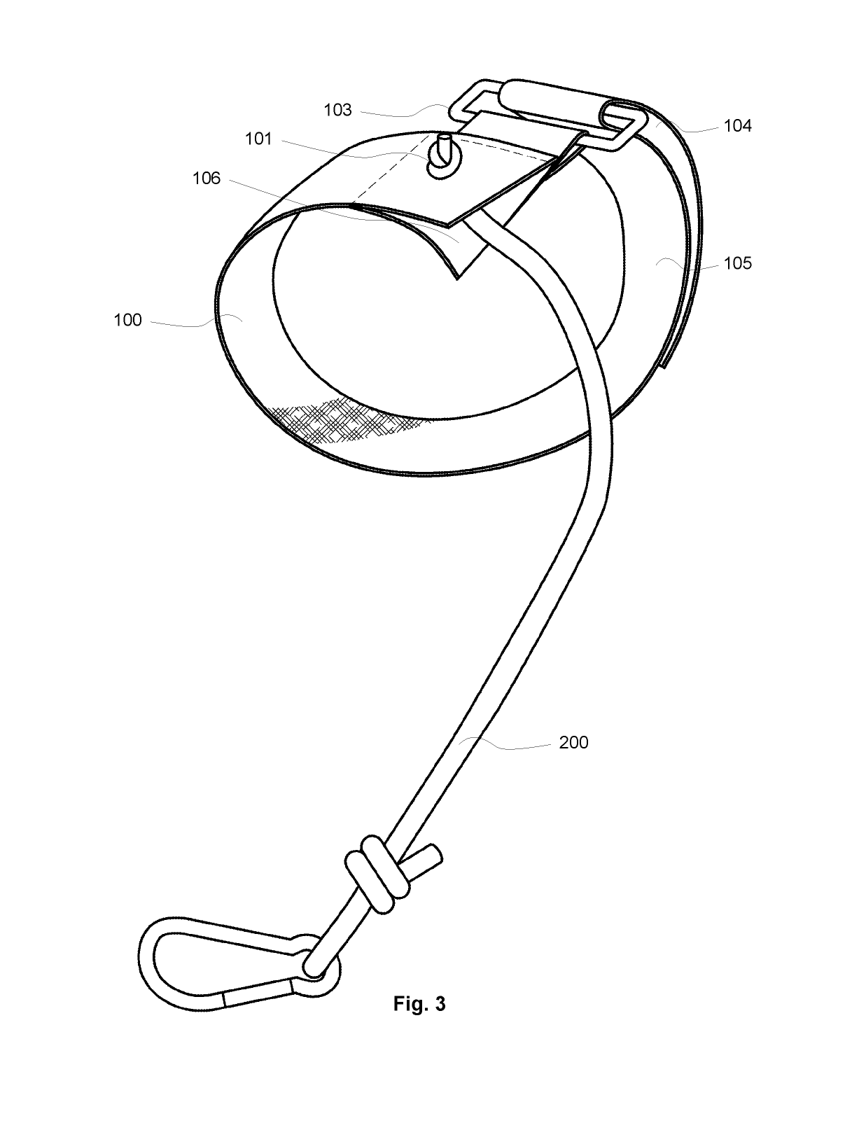

In some embodiments, wrist strap 100 may be comprised of a substantially flexible material, such as a fabric. One purpose of wrist strap 100 is to transfer the weight of the article being transported from the hand of the carrier to the wrist, allowing the muscles of the arms and upper back to bear some of the load. Another purpose of wrist strap 100 is to allow a secure disposition around the wrist of the user, such that the means for transporting objects does not become displaced during transport. Another purpose of wrist strap 100 is to allow a user to easily place and remove the means for transporting objects, such that donning and removing the device can be done quickly, in adverse conditions, or when the user has other obstacles, such as gloves or other items, with which to contend. For at least these reasons, wrist strap 100 may include additional material properties. For instance, in some embodiments, wrist strap 100 may be comprised of a very strong material, such as nylon, that is capable of withstanding hundreds or thousands of pounds of pull stress. In some embodiments, wrist strap 100 may be comprised of an elastic material that can be deformed in order to be easily placed or removed from the user's wrist. In some embodiments, wrist strap 100 may include adjustment means 103, which will be discussed further with FIG. 3. In some embodiments, wrist strap 100 may be comprised of multiple layers, such as a protective outer layer like nylon and a padded middle layer such as a foam. In some embodiments, wrist strap 100 may have many layers, such as an outward facing layer of protective material, a padded layer, and an inward facing layer of a gentle material, such as fleece, to prevent chafing of the user's skin.

In some embodiments, tether 200 may be comprised of a substantially flexible material, such as fabric, rope, leather, etc. One purpose of tether 200 is to be disposed over or around an object to be transported, in order to provide a means for lifting the object. Another purpose of tether 200 is to be disposed over or around objects of different shapes and sizes. Another purpose of tether 200 is to be capable of withstanding heavy weights downwards and at angles to wrist strap 100. For at least these reasons, tether 200 may include additional material properties. For instance, in some embodiments, tether 200 may be comprised of a very strong material, such as nylon, that is capable of withstanding hundreds or thousands of pounds of pull stress. In some embodiments, tether 200 may be comprised of a material that is resistant to cutting or heat. In some embodiments, tether 200 may be comprised of a particularly light material, such that it does not add weight to the load to be transported.

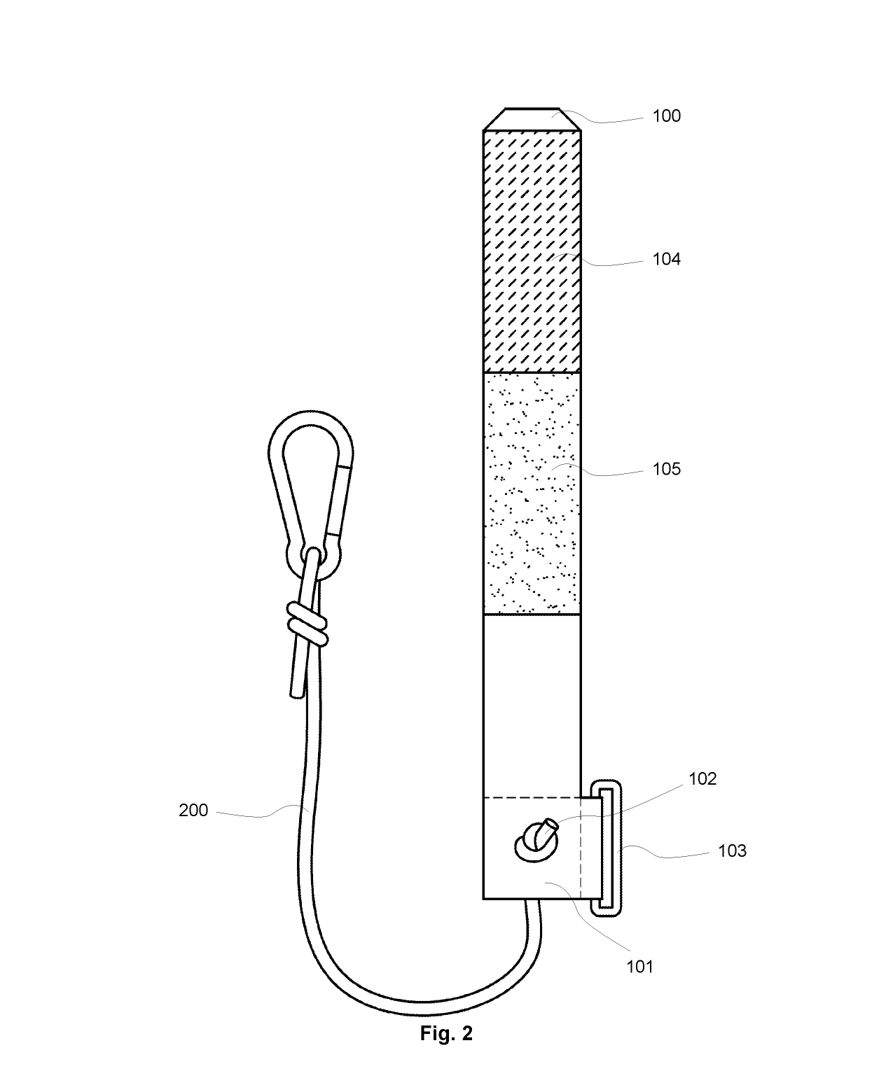

In some embodiments, wrist strap 100 may be coupled with tether 200 at joint 101. In some embodiments, joint 101 may include a coupling means, such as a snap, a knot 102 (see FIG. 2), a hook-and-loop configuration such as Velcro®, a fabric weld, a buckle, or other fastening means appropriate for coupling a first substantially flexible material with a second substantially flexible material. In some embodiments, joint 101 may be disposed within a pocket 106. In some embodiments, the joint between wrist strap 100 and tether 200 may be removable, such that one of the wrist strap or the tether can be removed. In some embodiments, tether 200 may be removable and interchangeable, such that different tethers with different material properties can be transported. In some embodiments, tether 200 may be adjustable in length. In some further embodiments, that may be accomplished by adjusting the joint between wrist strap 100 and tether 200. In other further embodiments, tether 200 may include an adjustment means similar to adjustment means 103 in wrist strap 100. In still other embodiments, tether 200 may be adjustable in length via a retractable cord method. It should be understood that many methods of adjusting the length of tether 200 may be practiced without altering the function of the length adjustment.

In some embodiments, tether 200 may include a looping means 201. One purpose of looping means 201 is to allow tether 200 to be removably disposable around or over an object to be transported. Another purpose of looping means 201 may be to allow tether 200 to attach to a loop, hook, eyelet, or other coupling means on the object to be transported. Another purpose of looping means 201 may be to provide additional material properties, such as strength or shear resistance. In some embodiments, many of these purposes may be achieved by the use of a loop with a spring-loaded gate, such as a carabiner, for looping means 201. In some embodiments, looping means 201 may be lockable, by way of screw-lock, twist-lock, magnetic, double-gate, or other locking mechanisms. In some embodiments, looping means 201 may be a hook designed to catch and hold some portion of wrist strap 100 or tether 200. In some embodiments, looping means 201 may be coupled with tether 200 at joint 202. In some embodiments, joint 202 may be a knot formed by disposing some portion of tether 200 through some portion of looping means 201, then knotting the tether around itself In some embodiments, tether 200 may be disposed through looping means 201 and then crimped. In some embodiments, looping means 201 may be coupled with tether 200 with a cement. In some embodiments, tether 200 may be a chain, which may be coupled with looping means 201 by passing the looping means through a link of the chain or via a weld.

FIG. 2 is a rear view of one embodiment of the means for transporting objects. In some embodiments, wrist strap 100 may be comprised of more than one section. For example, in some embodiments, the inward facing layer of wrist strap 100 may have two sections designed to be coupled. In some embodiments, section 104 may include a male or female half of a snap, and section 105 may include the opposite half. In some embodiments, section 104 may contain a male or female half of a snap, and section 105 may contain multiple complementary halves in order to create an adjustable-length wrist strap. In one preferred embodiment, depicted in FIG. 2, wrist strap 100 includes an upper section 104 and a lower section 105, which together form a hook-and-loop means of fastening. When the upper end of strap 100 is disposed through adjusting means 103, section 104 can be brought to couple with section 105 at a length that is most comfortable for the user.

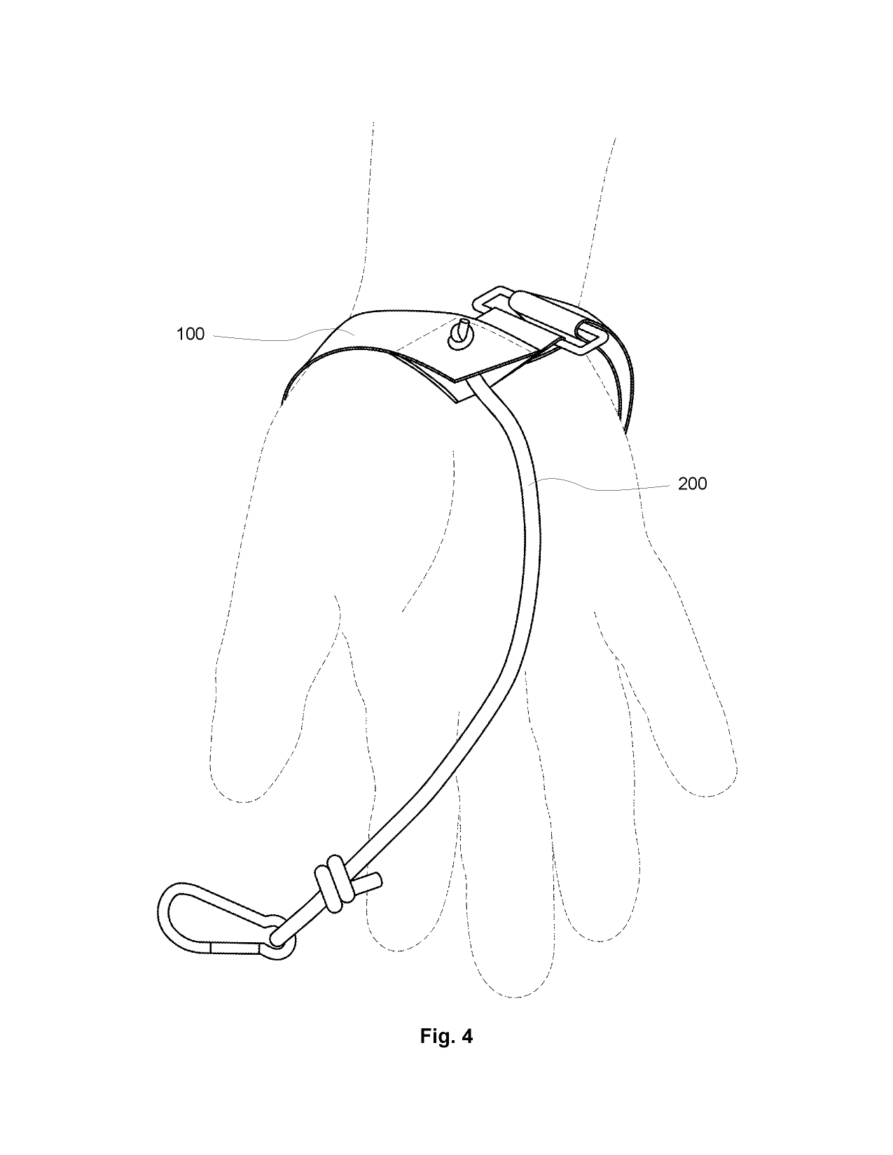

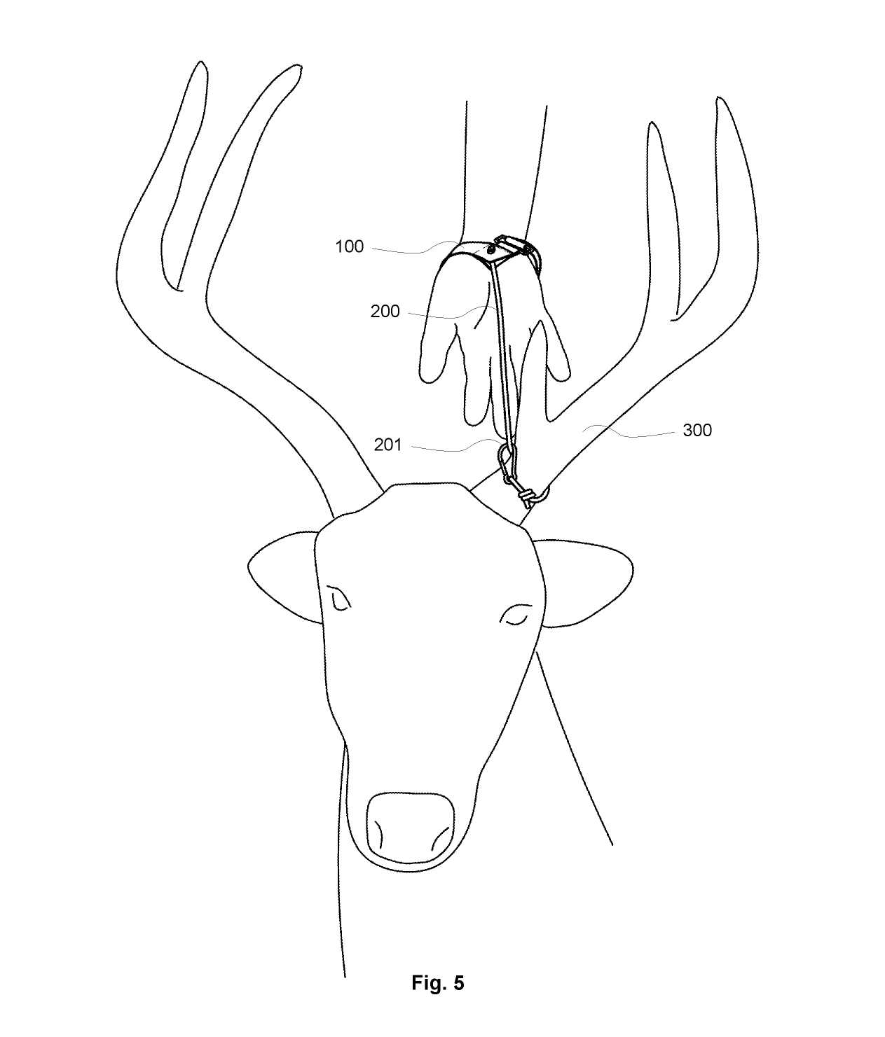

FIG. 3 is an isometric view of one embodiment of the means for transporting objects, wherein the wrist strap 100 is shown in a closed position. This shows how section 104 can be disposed through adjusting means 103 and brought to couple with section 105, creating a loop out of strap 100. FIG. 3 also depicts how, in one embodiment, the location of adjusting means 103 can help to properly arrange strap 100 such that pocket 106 and joint 101 are downward facing, allowing tether 200 to hang below the user's hand. FIG. 4 is an environmental view of the same embodiment, showing it in place on the user's hand. In one method of use, the user can let tether 200 hang from wrist strap 100 such that the user can grip the tether, keeping the object to be carried closer to the user's body. In another method of use, the user can turn the device such that tether 200 hangs down the back of the user's hand, allowing the user to carry other objects in his or her hand, or to walk with a more natural stride. FIG. 5 is an environmental view of one embodiment of the means for transporting objects, showing the device in one method of use. Here, tether 200 is disposed around the object 300, here a deer's antler, via a loop formed with looping means 201. Wrist strap 100 is disposed around the user's wrist, leaving the user's hand free. This is beneficial first because the user does not have to bear 300 pounds of deadweight in his or her hands, and second because it leaves the user's hand free to carry smaller objects, such as canteens or travel bags.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A carrying device, comprising:
a strap configured for looping; and
a tether, the tether disposed at one end of the strap and coupled thereto by at least one adjustable joint.

2. The carrying device of claim 1, wherein the strap configured for looping further comprises:
at least one means for adjusting the length of the strap.

3. The carrying device of claim 1, wherein the strap configured for looping further comprises:
at least one means for removably joining a first end of the strap with a second end of the strap in order to create a loop.

4. The carrying device of claim 1, wherein the strap configured for looping further comprises:
at least one means for adjusting the size of a loop.

5. The carrying device of claim 1, wherein the tether further comprises:
a first end and a second end, wherein the first end is coupled with the strap, and
wherein the second end is coupled with at least one looping means.

6. A carrying device, comprising:
a strap with a first end and a second end, the strap including at least:
an upper section disposed near the first end of the strap, the upper section including one half of a fastening system;
a lower section disposed near the second end of the strap, the lower section including a complementary half of a fastening system; and
an adjuster loop disposed at the second end of the strap; and
a tether with a first end and a second end, wherein the first end of the tether is coupled with the second end of the strap, and
wherein the second end of the tether is coupled with at least one looping means.

7. The carrying device of claim 6, wherein the fastening means includes a snap system.

8. The carrying device of claim 6, wherein the fastening means includes a hook-and-loop system.

9. The carrying device of claim 6, wherein the looping means includes a spring-loaded gate mechanism.
